(19) United States
(12) Patent Application Publication
(10) Pub. No.: US 2023/0138894 A1
(43) Pub. Date: May 4, 2023

(54) LIFTING FAN FOR HOVERCRAFT

(71) Applicant: K-MARINE CO., LTD., Jeollabuk-do (KR)

(72) Inventors: Chan Woo LEE, Jeollabuk-do (KR); Hye Sook JUNG, Jeollabuk-do (KR)

(21) Appl. No.: 17/969,745

(22) Filed: Oct. 20, 2022

(30) Foreign Application Priority Data
Nov. 3, 2021 (KR) 10-2021-0150103

(51) Int. Cl. B60V 1/14; F04D 19/00; F04D 29/52; B60V 1/04

(52) U.S. Cl. CPC B60V 1/14; F04D 19/002; F04D 29/522; B60V 1/04

(57) ABSTRACT

A lifting fan for hovercraft of the present disclosure comprises an upper shroud that is higher in its center and lower on its outer side, an air inlet part formed in the center of the upper shroud, a lower shroud that is higher in its center and lower on its outer side, a rotating shaft coupled to the center of the lower shroud, a plurality of blowing blades formed between the upper shroud and the lower shroud, a blowing passage formed with an inclination between the upper shroud, the lower shroud, and the plurality of blowing blades, and an air outlet part formed on the outer side of the upper shroud, on the outer side of the lower shroud, and at distal ends of the plurality of blowing blades, and thus has the effect of being excellent in the efficiency of air flow and of reducing the amount of noise and vibration generated in the process in which the air introduced through the air inlet part is discharged through the air outlet part by way of the inclined blowing passage.

### CROSS-REFERENCES TO RELATED APPLICATIONS

This application claims the benefit and priority to Korean Application No. 10-2021-0150103 filed on Nov. 3, 2021, the disclosure of which is incorporated herein by reference in its entirety.

### FIELD OF THE DISCLOSURE

The present disclosure relates to a lifting fan for hovercraft, and more specifically, to a lifting fan for hovercraft that results in smooth air discharge from the air inlet part to the air outlet part and that reduces the noise and vibration generated in the process in which the air introduced through the air inlet part is discharged to the air outlet part having an angle of 90° by having the angle between the air inlet part and air outlet part of the lifting fan for hovercraft deviated from 90° so that the blowing passage has an inclination, or by placing a streamlined shroud between the air inlet part and air outlet part of the lifting fan for hovercraft so that the blowing passage has a streamlined shape.

### BACKGROUND

In general, a hovercraft is a ship that operates in a floating state with its hull not touching the water by jetting air downwards from the hull, and refers to an amphibious vessel that has little resistance due to water density and does not have screws and accordingly has the advantage of being able to operate in various places such as the terrain where usual ships cannot operate, swamps or coasts with aquatic plants or seaweeds, snow, mud, and sand.

Due to these advantages, the demand for hovercraft has recently increased rapidly, which in turn has accelerated technological development. In particular, the demand and supply are expanding to military use, cruise ships, and leisure boats.

In general, a hovercraft consists of a propeller for propulsion, a lifting fan for compressing air, a skirt, and the like. In such a hovercraft, when the lifting fan for compressing air rotates and draws air in through the air inlet part and supplies it to the lower side of the hull through the air outlet part, the skirt is expanded by the air supplied to the lower side, and an air cushion is created between the hull and the water surface, to thereby lift the hull. Then, when the propeller for propulsion operates, the hull moves in a floating state.

FIG. 1 is a diagram showing the figure of a conventional lifting fan for compressing air used in a hovercraft. According to FIG. 1, the lifting fan for compressing air used in a conventional hovercraft comprises an upper shroud 10, an air inlet part 20, a lower shroud 30, a rotating shaft 40, a plurality of blowing blades 50, a blowing passage 60, and an air outlet part 70, and the air inlet part 20 and the air outlet part 70 form an angle of 90°, so that the air introduced vertically through the air inlet part 20 is discharged horizontally through the air outlet part 70. That is, in the process in which the air introduced vertically through the air inlet part 20 is discharged horizontally through the air outlet part 70, there may arise a problem that a collision occurs in the flow of air and the efficiency of the air flow decreases. In addition, there may arise a problem that noise and vibration may be generated due to the collision occurring in the flow of air in the process in which the air introduced vertically through the air inlet part 20 is discharged horizontally through the air outlet part 70.

As prior art related to hovercraft, Korean Patent No. 10-1492373 (Patent Document 1) is disclosed.

Patent Document 1 relates to a hovercraft, comprising a hull 10 having a bottom 11, a fan 20 for generating propulsion air, a skirt-shaped floating body 16 provided on the bottom surface of the bottom 11 of the hull 10 and configured to lift the hull by the propulsion air provided by the fan 20, and a steering mechanism 50A and 50B configured to control the flow direction of the propulsion air generated by the fan 20 and to move the hull 10 forward or backward or to turn, wherein the fan 20 is arranged horizontally at the rear of the hull so that its rotating shaft 21 faces the hull bottom 11 and is configured to draw the air above the hull 10 in and to send out the propulsion air toward the hull bottom 11, the hovercraft further comprises left/right propulsion air discharge ducts 40A and 40B provided to extend along the longitudinal direction of the hull on the left and right sides of the hull 10, respectively, and a propulsion air distribution chamber 30, the internal space of which is partitioned into a propulsion air supply chamber Si and a floating air supply chamber S2 by an intermediate partition wall 32, so as to draw the propulsion air sent out by the fan 20 into the internal space arranged below the fan 20 and surrounded by side walls, to distribute the propulsion air into the left/right propulsion air discharge ducts 40A and 40B through outlet ports 33A and 33B of the side walls, and to simultaneously distribute it into the skirt-shaped floating body 16 through the outlets 17 of the hull bottom 11, the steering mechanism 50A and 50B comprises propulsion air flow direction diversion plates 51A and 51B installed rotatably at the position where the outlet ports 33A and 33B of the propulsion air distribution chamber 30 are formed, inside the center of the entire longitudinal direction of the propulsion air discharge ducts 40A and 40B and configured to redirect the propulsion air supplied from the propulsion air supply chamber Si to the front or rear of the propulsion air discharge ducts 40A and 40B, and adjustment levers 52A and 52B configured to rotate and redirect the propulsion air flow direction diversion plates 51A and 51B, and on the outer side of the propulsion air discharge ducts 40A and 40B, bypass air passages 48A and 48B configured to bypass the external air colliding in the direction opposite to the traveling direction of the hull 10 are installed parallel to the propulsion air discharge ducts 40A and 40B.

However, the lifting fan for compressing air used in the hovercraft in the prior art including Patent Document 1 still has the problem of deteriorating the efficiency of air flow and generating noise and vibration by the collision in the process in which the air introduced vertically through the air inlet part is discharged horizontally through the air outlet part since the air inlet part and the air outlet part form an angle of 90°.

### PRIOR ART LITERATURE

### Patent Documents

(Patent Document 1) Registered Korean Patent No. 10-1492373 (Date: Feb. 12, 2015)

### SUMMARY OF THE DISCLOSURE

### Technical Objects

In resolving the problems described above, it is an object of the present disclosure to provide a lifting fan for hovercraft that is excellent in the efficiency of air flow in the process in which the air introduced through an air inlet part is discharged through an air outlet part by way of an inclined blowing passage by forming the inclined blowing passage between an upper shroud and a lower shroud that are higher in their center and lower on their outer side, and a plurality of blowing blades.

Further, it is an object of the present disclosure to provide a lifting fan for hovercraft that reduces the amount of noise and vibration generated in the process in which the air introduced through the air inlet part is discharged through the air outlet part by way of the inclined blowing passage by forming the inclined blowing passage between the upper shroud and the lower shroud that are higher in their center and lower on their outer side, and the plurality of blowing blades.

Moreover, it is an object of the present disclosure to provide a lifting fan for hovercraft that is excellent in the efficiency of air flow in the process in which the air introduced through the air inlet part is discharged through the air outlet part by way of a blowing passage formed in a streamlined shape by having the blowing passage formed in a streamlined shape between an upper shroud and a lower shroud that have a streamlined shape from their center to their outer side and the plurality of blowing blades.

Furthermore, it is an object of the present disclosure to provide a lifting fan for hovercraft that reduces the amount of noise and vibration generated in the process in which the air introduced through the air inlet part is discharged through the air outlet part by way of the blowing passage formed in a streamlined shape by having the blowing passage formed in a streamlined shape between the upper shroud and the lower shroud that have a streamlined shape from their center to their outer side and the plurality of blowing blades.

In addition, it is an object of the present disclosure to provide a lifting fan for hovercraft, in which a force is applied from an upper shroud having a shorter cross-sectional length to the direction of a lower shroud having a longer cross-sectional length and which increases the velocity of the air discharged through the air outlet part in the process in which the air introduced through the air inlet part is discharged through the air outlet part by way of the blowing passage formed between the upper shroud and the lower shroud by forming a plurality of bends on the surface of the lower shroud.

### Technical Solution

A lifting fan for hovercraft in accordance with an embodiment of the present disclosure comprises an upper shroud that is higher in its center and lower on its outer side, an air inlet part formed in the center of the upper shroud, a lower shroud that is higher in its center and lower on its outer side, a rotating shaft coupled to the center of the lower shroud, a plurality of blowing blades formed between the upper shroud and the lower shroud, a blowing passage formed with an inclination between the upper shroud, the lower shroud, and the plurality of blowing blades, and an air outlet part formed on the outer side of the upper shroud, on the outer side of the lower shroud, and at distal ends of the plurality of blowing blades.

In this case, in the lifting fan for hovercraft in accordance with an embodiment of the present disclosure, the blowing passage may be formed with an inclination angle a of 30° to 60°.

In this case, in the lifting fan for hovercraft in accordance with an embodiment of the present disclosure, the upper shroud may have a streamlined shape from the center to the outer side, the lower shroud may have a streamlined shape from the center to the outer side, and the blowing passage may be formed in a streamlined shape between the upper shroud, the lower shroud, and the plurality of blowing blades.

In this case, in the lifting fan for hovercraft in accordance with an embodiment of the present disclosure, the blowing passage may be formed in a streamlined shape having an eccentricity e of 0.4 to 0.9.

In this case, in the lifting fan for hovercraft in accordance with an embodiment of the present disclosure, a plurality of bends may be formed on the surface of the lower shroud.

In this case, the lifting fan for hovercraft in accordance with an embodiment of the present disclosure may have a material of CFRP (Carbon Fiber Reinforced Plastics).

### Effects of the Disclosure

As described above, the lifting fan for hovercraft in accordance with the present disclosure has the effect of being excellent in the efficiency of air flow in the process in which the air introduced through the air inlet part is discharged through the air outlet part by way of the inclined blowing passage by forming the inclined blowing passage between the upper shroud and the lower shroud that are higher in their center and lower on their outer side, and the plurality of blowing blades.

Further, the lifting fan for hovercraft in accordance with the present disclosure has the effect of reducing the amount of noise and vibration generated in the process in which the air introduced through the air inlet part is discharged through the air outlet part by way of the inclined blowing passage by forming the inclined blowing passage between the upper shroud and the lower shroud that are higher in their center and lower on their outer side, and the plurality of blowing blades.

Moreover, the lifting fan for hovercraft in accordance with the present disclosure has the effect of being excellent in the efficiency of air flow in the process in which the air introduced through the air inlet part is discharged through the air outlet part by way of the blowing passage formed in a streamlined shape by having the blowing passage formed in a streamlined shape between the upper shroud and the lower shroud that have a streamlined shape from their center to their outer side and the plurality of blowing blades.

Furthermore, the lifting fan for hovercraft in accordance with the present disclosure has the effect of reducing the amount of noise and vibration generated in the process in which the air introduced through the air inlet part is discharged through the air outlet part by way of the blowing passage formed in a streamlined shape by having the blowing passage formed in a streamlined shape between the upper shroud and the lower shroud that have a streamlined shape from their center to their outer side and the plurality of blowing blades.

In addition, the lifting fan for hovercraft in accordance with the present disclosure has the effect that a force is applied from the upper shroud having a shorter cross-sectional length to the direction of the lower shroud having a longer cross-sectional length and that increases the velocity of the air discharged through the air outlet part in the process in which the air introduced through the air inlet part is discharged through the air outlet part by way of the blowing passage formed between the upper shroud and the lower shroud by forming the plurality of bends on the surface of the lower shroud.

### BRIEF DESCRIPTION OF THE DRAWINGS

FIG. 1 is a diagram showing the figure of a conventional lifting fan for compressing air used in a hovercraft;

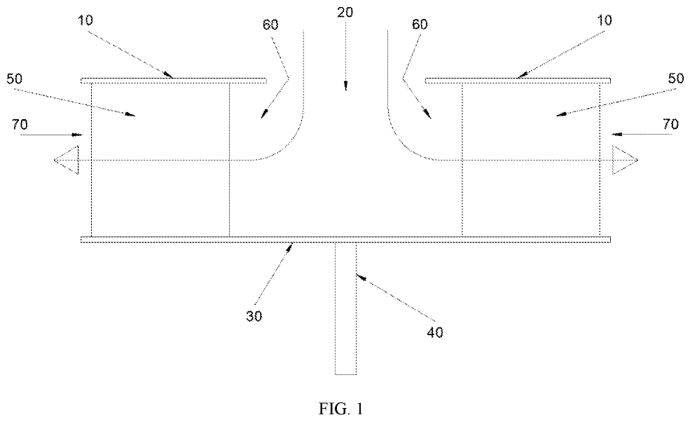

FIG. 2 is a diagram showing the figure of forming an inclined blowing passage between an upper shroud and a lower shroud that are higher in their center and lower on their outer side and a plurality of blowing blades, in a lifting fan for hovercraft in accordance with one embodiment of the present disclosure;

FIG. 3 is a diagram showing the figure of having a blowing passage formed in a streamlined shape between an upper shroud and a lower shroud that have a streamlined shape from their center to their outer side and a plurality of blowing blades, in a lifting fan for hovercraft in accordance with one embodiment of the present disclosure;

FIG. 4 is a diagram showing the figure of forming an inclined blowing passage between an upper shroud and a lower shroud that are higher in their center and lower on their outer side and a plurality of blowing blades, and of forming a plurality of bends on the surface of the lower shroud, in a lifting fan for hovercraft in accordance with one embodiment of the present disclosure; and

FIG. 5 is a diagram showing the figure of having a blowing passage formed in a streamlined shape between an upper shroud and a lower shroud that have a streamlined shape from their center to their outer side and a plurality of blowing blades, and of forming a plurality of bends on the surface of the lower shroud, in a lifting fan for hovercraft in accordance with one embodiment of the present disclosure.

### DETAILED DESCRIPTION OF THE PREFERRED EMBODIMENTS

In the present disclosure, the accompanying drawings may be illustrated in an exaggerated representation for the convenience of understanding the technology, as well as for differentiation and clarity from the prior art. In addition, since the terms to be described below are terms defined in consideration of the functions in the present disclosure and may vary depending on the intention of a user or operator or custom, definitions of these terms should be made individually based on the technical contents throughout this specification. On the other hand, the embodiments are merely illustrative matters of the components presented in the claims of the present disclosure and do not limit the scope of the present disclosure, and the scope of rights should be construed based on the technical idea throughout the specification of the present disclosure.

Further, before describing the present disclosure, it should be noted that matters that are not necessary to disclose the subject matter of the present disclosure, i.e., known configurations that can be added unambiguously by those of ordinary skill in the art, are not shown or specifically described.

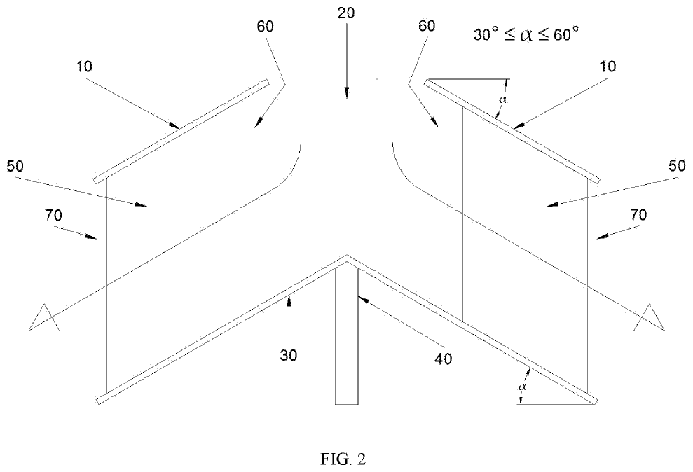

FIG. 2 is a diagram showing the figure of forming an inclined blowing passage between an upper shroud and a lower shroud that are higher in their center and lower on their outer side and a plurality of blowing blades, in a lifting fan for hovercraft in accordance with one embodiment of the present disclosure.

According to FIG. 2, a lifting fan for hovercraft in accordance with an embodiment of the present disclosure comprises an upper shroud that is higher in its center and lower on its outer side, an air inlet part formed in the center of the upper shroud, a lower shroud that is higher in its center and lower on its outer side, a rotating shaft coupled to the center of the lower shroud, a plurality of blowing blades formed between the upper shroud and the lower shroud, a blowing passage formed with an inclination between the upper shroud, the lower shroud, and the plurality of blowing blades, and an air outlet part formed on the outer side of the upper shroud, on the outer side of the lower shroud, and at distal ends of the plurality of blowing blades.

In the lifting fan for hovercraft in accordance with an embodiment of the present disclosure, the upper shroud 10 may have an inclined structure with a higher center and a lower outer side, and the air inlet part 20 may be formed at the highest central portion of the upper shroud 10. In other words, the upper shroud 10 may have a donut shape in which the air inlet part 20 is formed in the center, thereby having a hole bored therein, and the upper shroud 10 may have the shape of a cone with a hole having an inclined structure with a higher center and a lower outer side. The upper shroud 10 may have a shape symmetrical to the lower shroud 30, and the upper shroud 10 may be connected to the lower shroud 30 having a symmetrical structure thereto through the plurality of blowing blades 50. By being connected to the lower shroud 30 through the plurality of blowing blades 50, the lower shroud 30, the plurality of blowing blades 50, and the upper shroud 10 can rotate together when the rotating shaft 40 coupled to the center of the lower shroud 30 rotates.

In the lifting fan for hovercraft in accordance with an embodiment of the present disclosure, the air inlet part 20 for introducing air in the vertical direction may be formed at the highest portion of the center of the upper shroud 10. At this time, an inclination of greater than 90° to less than 180° may be formed between the air inlet part 20 through which air is introduced in the vertical direction and the air outlet part 70 through which air is discharged in the horizontal direction. The shape of the air inlet part 20 is not particularly limited, and may have various shapes such as a circle, a rectangle, a triangle, and the like. However, it is generally preferable to have a circular shape, and if the air inlet part 20 has a circular shape, the upper shroud 10 may have a donut shape with a circular hole bored in the center. External air is introduced into the inside of the lifting fan for hovercraft through the air inlet part 20. The air introduced into the inside of the lifting fan for hovercraft in the vertical direction from the outside collides with the central portion of the lower shroud 30 at an angle. The air introduced into the inside of the lifting fan for hovercraft in the vertical direction from the outside collides with the central portion of the lower shroud 30 at an angle of 90° in the conventional lifting fan in which the air inlet part 20 and the air outlet part 70 form an angle of 90°, whereas the air introduced into the inside of the lifting fan for hovercraft in the vertical direction from the outside collides with the central portion of the lower shroud 30 at an angle greater than 90° in the lifting fan for hovercraft of the present disclosure in which the air inlet part 20 and the air outlet part 70 form an angle greater than 90°. In the lifting fan for hovercraft of the present disclosure, as the air introduced into the inside of the lifting fan for hovercraft in the vertical direction collides with the central portion of the lower shroud 30 at an angle greater than 90°, a certain degree of cushioning action occurs, the efficiency of air flow is improved, and the amount of noise and vibration generated is reduced.

In the lifting fan for hovercraft in accordance with an embodiment of the present disclosure, the lower shroud 30 may have an inclined structure with a higher center and a lower outer side, and the rotating shaft 40 may be coupled to the center of the lower shroud 30. In other words, the lower shroud 30 may have a cone shape having an inclined structure with a higher center and a lower outer side. The lower shroud 30 may have a shape symmetrical to the upper shroud 10, and the lower shroud 30 may be connected to the upper shroud 10 having a symmetrical structure thereto through the plurality of blowing blades 50. By being connected to the upper shroud 10 through the plurality of blowing blades 50, the lower shroud 30, the plurality of blowing blades 50, and the upper shroud 10 can rotate together when the rotating shaft 40 coupled to the center of the lower shroud 30 rotates. In the lifting fan for hovercraft of the present disclosure, as the lower shroud 30 has an inclined structure with a higher center and a lower outer side, the air introduced into the inside of the lifting fan for hovercraft in the vertical direction collides with the central portion of the lower shroud 30 at an angle greater than 90°, and a certain degree of cushioning action occurs, the efficiency of air flow is improved, and the amount of noise and vibration generated is reduced.

In the lifting fan for hovercraft in accordance with an embodiment of the present disclosure, the rotating shaft 40 is coupled to the center of the lower shroud 30 and performs the function of rotating. The rotating shaft 40 is not particularly limited in its type or structure as long as it is coupled to the center of the lower shroud 30 and performs the function of rotating. As the rotating shaft 40 is coupled to the center of the lower shroud 30 and the lower shroud 30 is connected to the upper shroud 10 through the plurality of blowing blades 50, the lower shroud 30, the plurality of blowing blades 50, and the upper shroud 10 can rotate at the same time when the rotating shaft 40 rotates.

In the lifting fan for hovercraft in accordance with an embodiment of the present disclosure, the plurality of blowing blades 50 may be formed between the upper shroud 10 and the lower shroud 30. The plurality of blowing blades 50 means two or more, and a variable number may be formed depending on the performance and capacity of the lifting fan for hovercraft. As the plurality of blowing blades 50 is formed between the upper shroud 10 and the lower shroud 30 in the lifting fan for hovercraft in accordance with an embodiment of the present disclosure, when the rotating shaft 40 rotates, the lower shroud 30 coupled thereto rotates, and the plurality of blowing blades 50 and the upper shroud 10 can rotate together. By rotating the plurality of blowing blades 50 in the lifting fan for hovercraft in accordance with an embodiment of the present disclosure, air is introduced in the vertical direction from the outside through the air inlet part 20, and is discharged in the horizontal direction through the air outlet part 70 by way of the blowing passage 60.

In the lifting fan for hovercraft in accordance with an embodiment of the present disclosure, the blowing passage 60 may be formed with an inclination between the upper shroud 10, the lower shroud 30, and the plurality of blowing blades 50. Although there is no particular limitation on the cross-sectional shape of the blowing passage 60, since it is formed between the upper shroud 10, the lower shroud 30, and the two blowing blades 50, it generally has a rectangular cross-sectional shape. As the blowing passage 60 is formed with an inclination, the air inlet part 20 through which air is introduced in the vertical direction and the air outlet part 70 through which air is discharged in the horizontal direction have an inclination of greater than 90° to less than 180°. In addition, the blowing passage 60 may have an inclination of greater than 90° to less than 180° with respect to the vertical direction in which the air is introduced, and an inclination of greater than 0° to less than 90° with respect to the horizontal direction in which the air is discharged. In the lifting fan for hovercraft in accordance with an embodiment of the present disclosure, the blowing passage 60 is sufficient as long as it is formed between the upper shroud 10, the lower shroud 30, and the blowing blades 50 while having an inclination, and there is no particular limitation on the type or structure thereof.

In the lifting fan for hovercraft in accordance with an embodiment of the present disclosure, the air outlet part 70 configured to discharge air in the horizontal direction may be formed on the outer side of the upper shroud 10, on the outer side of the lower shroud 30, and at the distal ends of the plurality of blowing blades 50. There are no particular limitations on the type, structure, or shape of the air outlet part 70 as long as they perform the function of discharging air in the horizontal direction. However, since they are formed between the outer side of the upper shroud 10, the outer side of the lower shroud 30, and the distal ends of the two blowing blades 50, it is common to have a rectangular shape. At this time, an inclination of greater than 90° to less than 180° may be formed between the air inlet part 20 through which air is introduced in the vertical direction and the air outlet part 70 through which air is discharged in the horizontal direction.

In the lifting fan for hovercraft in accordance with an embodiment of the present disclosure, the blowing passage 60 formed between the upper shroud 10, the lower shroud 30, and the plurality of blowing blades 50 may have an inclination angle a of 30° to 60° with the horizontal line. In the lifting fan for hovercraft in accordance with an embodiment of the present disclosure, if the blowing passage 60 formed between the upper shroud 10, the lower shroud 30, and the plurality of blowing blades 50 has an inclination angle of less than 30° with the horizontal line, the cushioning effect of mitigating the impact gets relatively smaller when the air introduced into the inside of the lifting fan for hovercraft in the vertical direction collides with the central portion of the lower shroud 30, and there may thus arise a problem that the degree of the improvement in the efficiency of air flow and the reduction of noise and vibration generation is insufficient, and if the blowing passage 60 has an inclination angle of greater than 60° with the horizontal line, the pressure drops when the air introduced into the inside of the lifting fan for hovercraft in the vertical direction is supplied to the skirt in the horizontal direction through the air outlet part 70, and thus, the skirt cannot be sufficiently expanded, and the formation of an air cushion between the hull and the water surface is insufficient, which may cause a problem in floating the hovercraft hull.

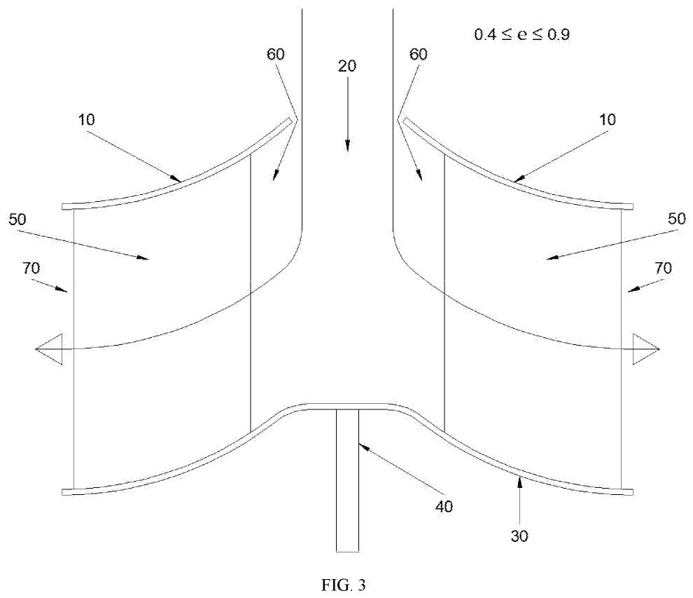

FIG. 3 is a diagram showing the figure of having a blowing passage formed in a streamlined shape between an upper shroud and a lower shroud that have a streamlined shape from their center to their outer side and a plurality of blowing blades, in a lifting fan for hovercraft in accordance with one embodiment of the present disclosure.

According to FIG. 3, in the lifting fan for hovercraft in accordance with an embodiment of the present disclosure, the upper shroud 10 may have a streamlined shape from the center to the outer side, the lower shroud 30 may have a streamlined shape from the center to the outer side, and the blowing passage 60 may be formed in a streamlined shape between the upper shroud 10, the lower shroud 30, and the plurality of blowing blades 50. As the blowing passage 60 is formed in a streamlined shape, the air inlet part 20 through which air is introduced in the vertical direction and the air outlet part 70 through which air is discharged in the horizontal direction will have an inclination of 90°. In this case, the angle formed by the blowing passage 60 and the vertical direction in which air is introduced decreases gradually from 180° to 90°, and the angle formed by the blowing passage 60 and the horizontal direction in which air is discharged increases gradually from 90° to 180°. In other words, while the air flowing in from the outside passes through the blowing passage 60 having a streamlined shape, the air flow changes continuously from the vertical direction of 90° to the horizontal direction of 180°.

In this case, in the lifting fan for hovercraft in accordance with an embodiment of the present disclosure, the blowing passage 60 may be formed in a streamlined shape with an eccentricity e of 0.4 to 0.9. The eccentricity e is a ratio indicating the degree of distortion of an ellipse, and the closer to 0, the closer to a circle, and the closer to 1, the more distorted the ellipse is. In this case, if the eccentricity e is less than 0.4, it is too close to a circular shape and thus, the air introduced into the inside of the lifting fan for hovercraft in the vertical direction may change rapidly to the horizontal direction, thereby causing a problem of generating vortex, and if the eccentricity e is greater than 0.9, it is closer to the shape of a horizontal line rather than a streamlined shape, the cushioning effect of mitigating the impact gets smaller when the air introduced into the inside of the lifting fan for hovercraft in the vertical direction collides with the central portion of the lower shroud 30, and there may arise a problem that the degree of the improvement in the efficiency of air flow and the reduction of noise and vibration generation is insufficient.

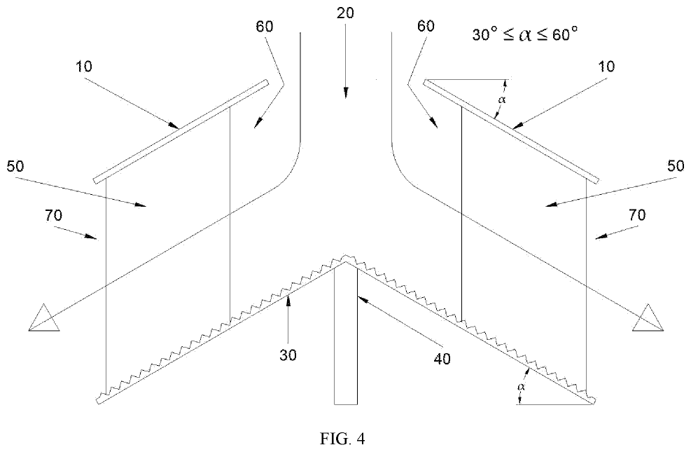

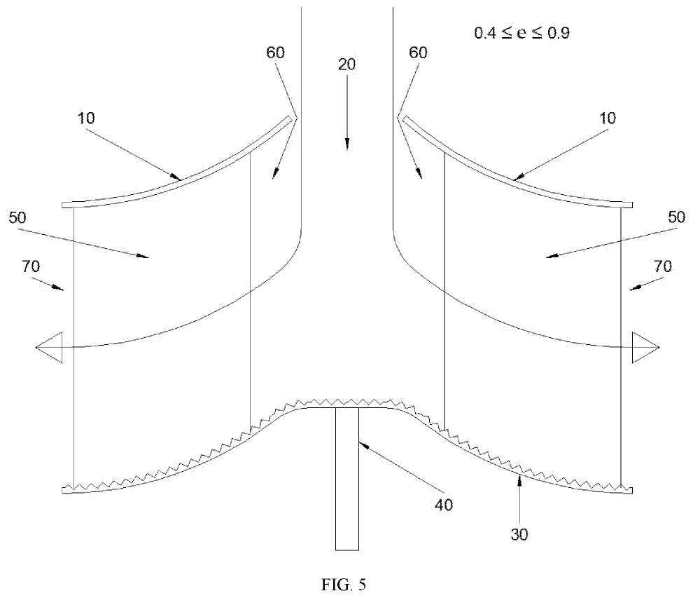

FIG. 4 is a diagram showing the figure of forming an inclined blowing passage between an upper shroud and a lower shroud that are higher in their center and lower on their outer side and a plurality of blowing blades, and of forming a plurality of bends on the surface of the lower shroud, in a lifting fan for hovercraft in accordance with one embodiment of the present disclosure, and FIG. 5 is a diagram showing the figure of having a blowing passage formed in a streamlined shape between an upper shroud and a lower shroud that have a streamlined shape from their center to their outer side and a plurality of blowing blades, and of forming a plurality of bends on the surface of the lower shroud, in a lifting fan for hovercraft in accordance with one embodiment of the present disclosure.

According to FIGS. 4 and 5, a plurality of bends 80 may be formed on the surface of the lower shroud 30. As the plurality of bends 80 is formed on the surface of the lower shroud 30, the velocity of the air passing through the upper shroud 10 having a shorter cross-sectional length gets relatively slower, thereby reducing the pressure and the velocity of the air passing through the lower shroud 30 having a longer cross-sectional length gets relatively higher, resulting in an increase in pressure when the air introduced through the air inlet part 20 passes through the blowing passage 60 formed between the upper shroud 10 and the lower shroud 30. Accordingly, a force is applied from the portion of the upper shroud 10 where the pressure is lower to the direction of the lower shroud 30 where the pressure is higher. In other words, when a force is applied from the upper shroud 10 having a shorter cross-sectional length to the direction of the lower shroud 30 having a longer cross-sectional length, there occurs an effect of increasing the velocity of the air discharged through the air outlet part, and the discharge air pressure is increased when the same energy is used as compared to the case where the plurality of bends 80 are not formed, to thereby expand the skirt sufficiently, and to sufficiently form an air cushion between the hull and the water surface, resulting in an advantage of easily floating the hovercraft hull. There is no particular limitation on the number of the plurality of bends 80 formed on the surface of the lower shroud 30, and it can be adjusted by increasing the number if there is a greater need to increase the pressure of the air discharged by the lifting fan for hovercraft of the present disclosure and by decreasing the number if there is not a great need to increase the pressure of the discharged air.

The lifting fan for hovercraft in accordance with an embodiment of the present disclosure may have a material of CFRP (Carbon Fiber Reinforced Plastics). CFRP is a lightweight structural material with high strength and high elasticity using carbon fiber as a reinforcing material, and has excellent strength and fatigue properties, is excellent in dimensional stability as it has a small coefficient of thermal expansion, has excellent corrosion resistance and vibration damping properties, is excellent in friction and abrasion resistance, and the like, and thus, has characteristics suitable for use in the lifting fan for hovercraft of the present disclosure that must maintain strength for a long time while having light weight.

As set forth above, the present disclosure has been described with reference to the embodiments shown in the drawings, which are, however, merely illustrative, and it should be understood that various modifications and equivalent other embodiments are possible based on common knowledge in the art to which the present technology pertains. Therefore, the true technical protection scope of the present disclosure is based on the claims to be described below, and should be determined based on the specific contents of the disclosure set forth above.

### INDUSTRIAL APPLICABILITY

The present disclosure relates to a lifting fan for hovercraft, and can be used in industrial fields related to air cushion vehicles such as hovercrafts.

### DESCRIPTION OF REFERENCE NUMERALS AND SYMBOLS

10: Upper shroud

20: Air inlet part

30: Lower shroud

40: Rotating shaft

50: Plurality of blowing blades

60: Blowing passage

70: Air outlet part

What is claimed is:

1. A lifting fan for hovercraft, comprising:
an upper shroud that is higher in its center and lower on its outer side;
an air inlet part formed in the center of the upper shroud;
a lower shroud that is higher in its center and lower on its outer side;
a rotating shaft coupled to the center of the lower shroud;
a plurality of blowing blades formed between the upper shroud and the lower shroud;
a blowing passage formed with an inclination between the upper shroud, the lower shroud, and the plurality of blowing blades; and
an air outlet part formed on the outer side of the upper shroud, on the outer side of the lower shroud, and at distal ends of the plurality of blowing blades.

2. The lifting fan for hovercraft of claim 1, wherein the blowing passage is formed with an inclination angle a of 30° to 60°.

3. The lifting fan for hovercraft of claim 1, wherein the upper shroud has a streamlined shape from the center to the outer side,
the lower shroud has a streamlined shape from the center to the outer side, and
the blowing passage is formed in a streamlined shape between the upper shroud, the lower shroud, and the plurality of blowing blades.

4. The lifting fan for hovercraft of claim 3, wherein the blowing passage is formed in a streamlined shape having an eccentricity e of 0.4 to 0.9.

5. The lifting fan for hovercraft of claim 1, wherein a plurality of bends is formed on the surface of the lower shroud.

6. The lifting fan for hovercraft of claim 1 , comprising a material of CFRP (Carbon Fiber Reinforced Plastics).
